(19) United States
(12) Patent Application Publication
(10) Pub. No.: US 2024/0351397 A1
(43) Pub. Date: Oct. 24, 2024

(54) VEHICLE CLIMATE CONTROL SYSTEM UTILIZING A FLEXIBLE HEAT PUMP

(71) Applicant: HONEYWELL INTERNATIONAL INC., Charlotte, NC (US)

(72) Inventors: Sanmao BAI, Shanghai (CN); Curt VINCENT, Grand Rapids, MI (US); Michael PETERSEN, Buffalo, NY (US); Tao LIU, Shanghai (CN); Nilesh PUROHIT, Charlotte, NC (US)

(73) Assignee: HONEYWELL INTERNATIONAL INC., Charlotte, NC (US)

(21) Appl. No.: 18/639,843

(22) Filed: Apr. 18, 2024

Related U.S. Application Data
(60) Provisional application No. 63/460,117, filed on Apr. 18, 2023.

(51) Int. Cl. B60H 1/00

(52) U.S. Cl. CPC B60H 1/00921; B60H 1/00278; B60H 1/00385; B60H 2001/00307; B60H 2001/00928; B60H 2001/00949

(57) ABSTRACT

A heat transfer system to alternatively and/or simultaneously provide heating and cooling in a mobile vehicle that includes an electrical power source requiring heating and/or cooling during charging and/or operation and that includes a cabin that requires heat input during low temperature ambient conditions.

### CROSS-REFERENCE TO RELATED APPLICATION

The present application claims the priority benefit of U.S. Provisional Application No. 63/460,117, filed on Apr. 18, 2023, which is incorporated herein by reference in its entirety.

### FIELD

The present invention relates to thermal management systems for electric vehicles and in particular to a flexible and efficient climate control system arrangement and method utilizing a heat pump for such vehicles.

### BACKGROUND

A vehicle, such as a car or truck, that is propelled solely by one or more electric motors, sometimes referred to as a traction motor, is typically referred to as an electric vehicle or an EV. In a hybrid electric vehicle, or HEV, one or more traction motors are used in conjunction with another power source, such as for example an internal combustion engine, including both gasoline and diesel powered engines. In both cases, a battery or capacitor bank carried by the vehicle during operation provides an electrical current to the traction motor and other components that are driven by an electric current and which will generally generate heat during operations.

Because the propulsion systems of EVs do not include an internal combustion engine, a traditional internal combustion engine cooling system is not present, and therefore hot liquid coolant is unavailable for heating the interior of the cabin, cab, or passenger compartment of the vehicle. Although an internal combustion engine is included in HEVs, there are times when it may be desirable to operate the HEV without running the internal combustion engine, in which case heat may be unavailable from circulating hot liquid coolant to heating the interior of the cabin, cab, or passenger compartment. Furthermore, it is frequently required that, in addition to the need to heat the cabin, cab, or passenger compartment for the comfort of the occupants, heat is frequently also required to defrost the vehicle windows.

The development of a thermal management system to handle the heating and cooling needs of EVs is challenging for several reasons. For example, it has been known to provide another source of heat, such as electric heaters, in EVs to provide at least some of the heat needed by the vehicle as described above. Such electric heaters, however, typically draw electric current from the same on-board source of electricity that supplies current to the traction motor that is used to propel the vehicle. It can be a disadvantage to require the use of such a heating source since it can limit the range of the EV or limit the amount of miles in which an HEV is propelled by the traction motor.

Another challenge associated with the development of EVs and HEVs thermal management system is that such systems also require the ability to cool the cabin, cab, or passenger compartment during warmer weather. In conventional non-electric vehicles, such air conditioning is provided by a compressor that is mechanically driven by the internal combustion engine. Because an EV lacks an internal combustion engine, and because the internal combustion engine of a hybrid electric vehicle may be turned off for periods of time, it is desirable to provide an alternate source of cooling for the cab, cabin, or passenger compartment for such vehicles when air conditioning is desired.

Another challenge involves the potential need to manage the temperature of the battery and/or other electrical components of EVs, and potentially for some HEVs, when the vehicle is stationary, and the battery is being charged by an external source of electrical current, such as would occur at a charging station.

Therefore, heating and cooling of the cab, cabin, or passenger compartment of an EV or an HEV, including defrosting of the vehicle windows, is a challenging task that should provide effective and efficient thermal operation while having the lowest possible impact on the range of the vehicle or on environmental performance of the EV or HEV.

### SUMMARY

The present invention provides heat transfer systems to alternatively and/or simultaneously provide heating and cooling in a mobile vehicle that includes an electrical power source requiring temperature regulation during operation and that includes a cabin that requires heat input during low temperature ambient conditions, said system comprising:
a) a vapor compression refrigeration circuit located in said mobile vehicle comprising:
   a first refrigerant,
   (ii) a compressor for compressing said first refrigerant in the vapor state from a first pressure to a higher second pressure, said compressor being connected upstream to a refrigerant accumulator,
   (iii) an inner condenser for selectively condensing during low temperature ambient conditions at least a portion of said first refrigerant vapor from said compressor by rejecting heat to said cabin,
   (iv) an outside heat exchanger located downstream of said inner condenser to selectively either (1) condense during low temperature ambient conditions at least a portion of said higher pressure refrigerant vapor not condensed in said inner condenser by rejecting heat, directly or indirectly, to ambient air and/or to a circulating coolant or (2) evaporate during high temperature ambient conditions low pressure refrigerant liquid from said inner condenser vapor;
   (v) a first open/closed/expansion device connected between said inner condenser and said outside heat exchanger for selectively (1) providing in an expansion mode a flow of reduced pressure liquid refrigerant from said inner condenser to said outside heat exchanger; (2) allowing in an open mode said condensed high pressure refrigerant from said condenser to pass to said outside condenser without pressure drop to said outside heat exchanger; or (3) preventing in a closed mode the flow of refrigerant from said inner condenser to said outside heat exchanger;
   (v) a inside heat exchanger fluidly connectable to said refrigerant downstream of said inner condenser for selectively heating to a flow of cabin air;
   (vi) a chiller fluidly connectable to said refrigerant downstream of said inner condenser for selectively heating a flow of liquid coolant;
   (vii) a bypass channel system connected upstream of said first open/closed/expansion device and downstream of said outside heat exchanger for selectively routing said refrigerant from said inner condenser and/or from said outside heat exchanger (1) around said first expansion device and to either (A) a second open/closed/expansion device fluidly connected to said inside heat exchanger for selectively (a) providing in an expansion mode a flow of reduced pressure liquid refrigerant from said inner condenser to said inside heat exchanger; (b) allowing in an open mode said condensed high pressure refrigerant from said condenser or from said outside heat exchanger to pass without pressure reduction to said inside heat exchanger; or (c) preventing in a closed mode the flow of refrigerant to said inside heat exchanger; and/or (B) an expansion device fluidly connected to said chiller for selectively (a) providing in an expansion mode a flow of reduced pressure liquid refrigerant to said chiller; or (b) preventing in a closed mode the flow of refrigerant to said chiller; or (2) through said first open/closed/expansion device operating in the expansion mode through said outside heat exchanger to said accumulator;
b) a heat exchange network interconnected with said vapor compression refrigeration circuit to selectively; (i) deliver, directly or indirectly, at said outside heat exchanger and/or at said chiller evaporative heat from one or more of ambient air and/or heat associated with the generation or use of electrical power within the vehicle and/or at said inside heat exchanger either directly or indirectly from (1) ambient air and/or (2) said electrical power source located in said vehicle.

The present invention also provides a heat transfer systems as described above in which the refrigerant used in the vapor compression refrigeration circuit comprises, or consists essentially of, or consists of 2,3,3,3-tetrafluoropropene (R-1234yf).

The present invention also provides a heat transfer systems as described above in which the heat exchange network comprises a coolant circuit that comprises a coolant that absorbs waste heat from an electrical power source located in said vehicle during low temperature ambient conditions and rejects heat to said refrigerant in said chiller.

As used herein, the term “waste heat from an electrical power source” refers to heat that needs to be and/or can removed from an on-board battery or an electrically powered device or article powered by the on-board battery or an off-board source of electrical power, such as the charging source that is being used to charge the batter. By way of example, such devices include the vehicle battery, motor, inverter and other electrical devices carried by the vehicle.

### BRIEF DESCRIPTION OF THE DRAWINGS

FIG. 1 illustrates a schematic of a thermal management system for an EV according to one example of the present invention.

FIGS. 2A and 2B illustrate a schematic of a thermal management system for an EV according to a second example of the present invention.

FIGS. 3-32 illustrate respective schematics of the thermal management system, and the results of the operation thereof, based on the system illustrated in FIG. 2 for a series of different operating modes as described in Examples 1-30 hereof.

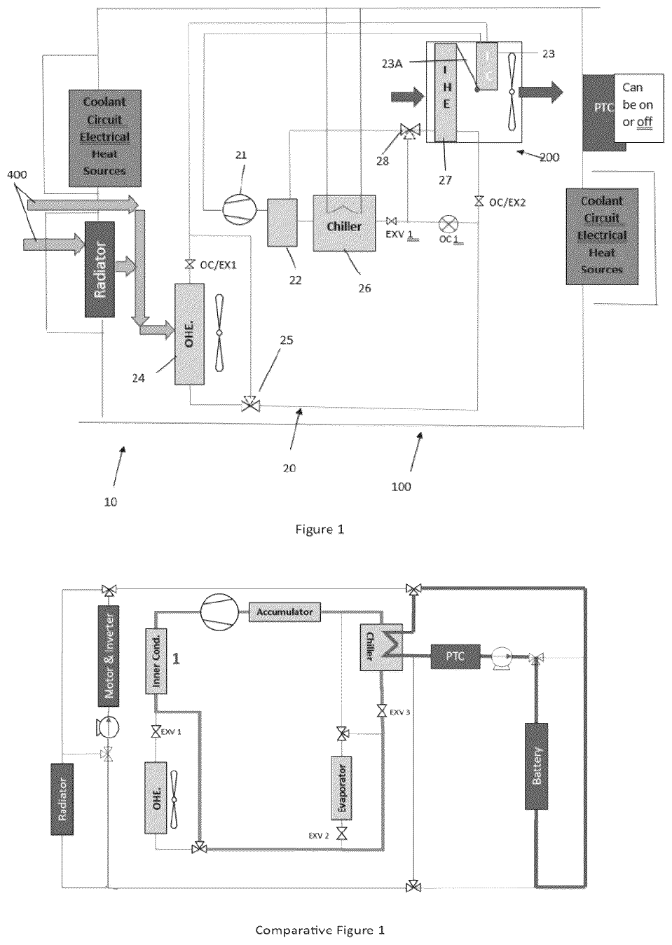

Comparative FIG. 1 illustrates a schematic of a thermal management system for an EV according to Comparative Example 1 hereof.

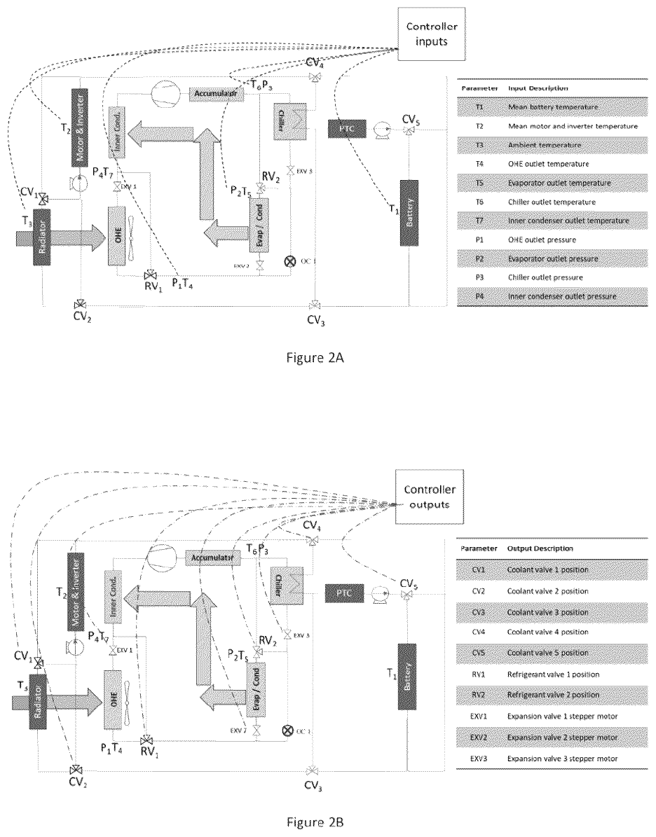

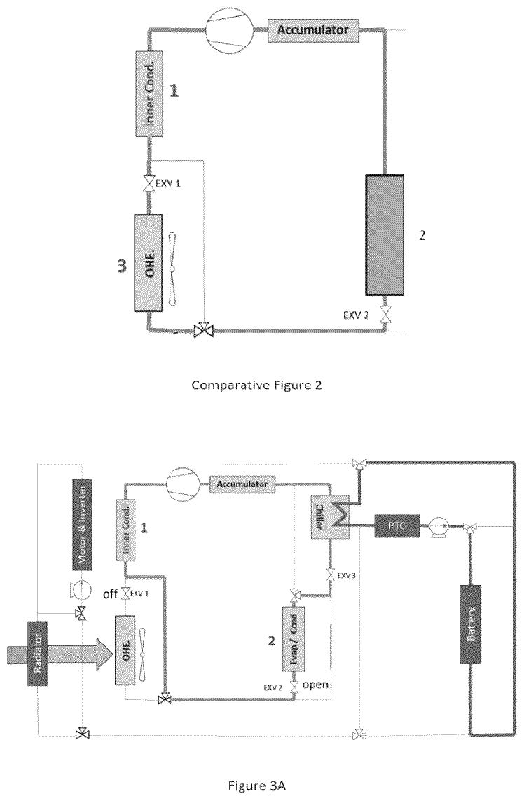

Comparative FIG. 2 illustrates a schematic of a thermal management system for an EV according to Comparative Example 2 hereof.

### DETAILED DESCRIPTION

An exemplary thermal management system according to the present invention is illustrated in FIG. 1 hereof. The thermal management system, including the components of the EV being heated or cooled, are designated generally as 10, and includes an area in which one or more person would travel, which is referred to generally herein as the “cabin” (not shown) and areas outside the cabin which will generally house the working components of the EV. Portions of the various thermal management systems of the present invention may be located within the cable and/or outside the cabin.

The system 10 of the present invention includes heat pump subsystem 52 may be a vapor compression system designated generally as 20 thermally interconnected with a coolant circuit, designated generally as 100, a cabin climate control module 200 and potentially also independently with a source of ambient air, designated as 300. It will be understood that since some of the components of the vapor compression circuit interface with some components of the coolant circuit and the climate control module 200, those portions may be properly designated as components of each of those portions of the system.

In particular, the vapor compression system includes a refrigerant, preferably R-1234yf, that circulates to various components of the present invention, a compressor 21, an accumulator 22 on the suction side of the compressor and inner condenser 23 located in the climate control module 200. The climate control module 200 includes a door 23A on the inner condenser 23 which can be moved to any position between a fully closed position (as shown) in which no cabin air which enters the control module can flow through the inner condenser to a fully open position in which the door permits air from the cabin to flow fully through the inner condenser and to be heated as it condenses at least a portion of the refrigerant which flows into the condenser from the discharge side of the compressor.

Refrigerant which exits the inner condenser is fluidly connected to an open/closed/expansion device (labeled as OC/EX1). The OC/EX1 is a known device that can be configured to take one of three possible actions: (1) change the pressure and temperature of the refrigerant flowing; (2) open fully so as to allow passage of refrigerant therethrough with minimal change in pressure of temperature; or (3) close so as to prevent the flow of refrigerant therethrough. The OC/EX devices that are used in the present invention may include an electronic actuator controlled controller (see FIGS. 2A and 2B), which may cause the actuator to position the expansion device in the wide-open position, in the fully closed position, or a throttled position in which flow is permitted by at a substantially reduced pressure and temperature. The throttled position typically is a partially open position where the controller
modulates the size of the valve opening to regulate flow through the expansion device. The controller and expansion devices may be configured to continuously or periodically modulate the throttled position in response to system operating conditions. By throttling the position of the expansion device, the controller can regulate flow, pressure, temperature, and state of the refrigerant as needed.

By operating the OC/EX1 in the fully opened position, the outside heat exchanger 24 (which is located outside the passenger cabin) can be used during low temperature ambient conditions in a supplemental condensation mode to condense at least a portion of any refrigerant vapor that is not condensed in the inner condenser 23 by rejecting heat to the relatively low temperature ambient air 400 directly, or preferably indirectly after ambient air has passed through the radiator of the circulating coolant system. During periods of high temperature ambient conditions, for example, the OC/EX1 can be operated in the throttled position and the outside heat exchanger can operate as an evaporator or alternatively the outside condenser can be bypassed by operating the OCEX1 in the fully closed position, which will direct the refrigerant flow from the inner condenser through the bypass conduit and to the divert valve 25.

The refrigerant which flows through the diverter valve 25 can be directed to chiller 26 and/or inner heat exchanger 27 or to bypass each of these and flow through diverter valve 28 directly to accumulator 22. An open/closed valve OC 1 may be provided downstream of diverter valve 25 and upstream of EXV1, and in the closed position blocks flow towards EXV1, thereby ensuring that refrigerant flows to OC/EX2. As an alternative in some cases, EXV1 may be provided as an OC/EV and operated in a closed position to prevent flow of refrigerant to the chiller, as illustrated in some of the examples below. A second open/closed/expansion device (labeled as OC/EX2) is provided upstream of the inner heat exchanger and can be operated to allow refrigerant to flow to the inner heat exchanger either in the fully open position (i.e., without substantial pressure reduction) or in the throttling mode. The OC/EX2 can also be operated in the fully closed position to prevent the flow of refrigerant to the inner heat exchanger 27.

As illustrated particularly in the following examples, the many advantages of the systems of the present include:
1—eliminate condensing capacity issues in cold weather;
2—eliminate icing issues at the outside heat exchanger;
3—eliminate the need for high voltage PTC (positive temperature coefficient) heaters inside the vehicle;
4—offset heating capacity reduction in cold weather
5—battery warming with PTC, if present, in very cold weather
6—using the inside heat exchanger either as an evaporator or a condenser extension and pre warmer
7—extending the heat pump initial air temperature range for R-1234yf;
8—using the outside heat exchanger (radiator) to reject heat from components instead of the chiller
9—warming the motor and inverter for higher efficiency before cold starts;
10—using the inside condenser for dehumidification reheat, which is more efficient than using PTC;
11—ability to use all sources for the heat pump (in any combination) at the OHE or chiller;
12—ability to cool all heat sources at the Radiator
13—ability to cool all heat sources at the Chiller
14—ability to self heat motor and inverter and battery independently.
15—ability to self heat motor and inverter and battery in series; and
16—ability to cool the motor and inverter (at outside heat exchanger (radiator)) and battery (at chiller) concurrently

### EXAMPLES

The following examples use another thermal management system according to an embodiment of the invention as illustrated in FIGS. 2A and 2B which provides the following advantageous features:
A) the ability to use at least the following four sources of evaporative energy available to use for heating, via heat pump, of an electric vehicle:
   1. Waste (or excess) energy from the motor and inverter
   2. Waste (or excess) energy from the battery
   3. Electrical energy from a heater (PTC)
   4. Free energy from the environment (air)
B) two locations within the system where energy can be absorbed (as the evaporative heat source) and used by the heat pump to warm the vehicle:
   1. The outside heat Exchanger (with airflow)
   2. The chiller (with coolant flow)

### Comparative Example 1 and Example 1—Heat Pump Mode to Warm Cabin Air

### Comparative Example 1

A typical prior heat pump system for use in an EV is illustrated in Figure C1 and is used as the basis for results of the data reported for this Comparative Example 1 (referred to as “CE1 data”). In this system battery waste heat is carried by a coolant (such as water/glycol for example) away from the battery and the PTC and is used as the evaporative heat source at the chiller of a vapor compression system, as shown above. This configuration may be effective in certain cases, but applicants have come to appreciate that in many modes of operation, including at relatively low ambient temperature conditions, full condensing is frequently not achieved at the inner condenser, which detracts for the capacity and effectiveness of such systems in such situations. This comparative example and Example 1 which follows is based upon the use of R-1234yf as the refrigerant.

### Example 1

Applicants have come to appreciate that when ambient temperatures are relatively low, EVs as previously configured can have a problem with insufficient condenser surface area to provide complete condensation, which can result in problems with system capacity and efficiency (COP). Applicants have found that a system as described herein can dramatically improve performance with relatively simple and low-cost modifications that provide not only unexpectedly superior performance but also high levels of operability over a wide variety of modes of cooling and heating to be carried out by the system. The present system configured for operation to heat cabin air during periods of low ambient temperatures is illustrated in FIG. 3A.

In this system, and in the remaining systems illustrated in the Examples, the label “Inner Cond” designates the same heat exchanger referenced in FIG. 1 as the internal condenser 23 and the heat exchanger designated as Evap/Cond designates the same heat exchanger designated as “internal heat exchanger” or IHE described and shown in FIG. 1 located in essentially the same relative positions and arrangement, including with presence of a door and cabin air as illustrated and explained in connection with FIG. 1. In addition, each of the Figures according to the present invention will have as needed an open/close valve to prevent the flow of refrigerant to the EXV leading to the chiller, even though such valve is not illustrated in these figures for convenience. It will be understood that these relative positions and features are present but not illustrated strictly for the purposes of convenience in this figure and the remaining figures to facilitate easier illustration of the system.

As illustrated in FIG. 1, the present system allows the ability to selectively alter the flow of refrigerant form the inner condenser 1 to the inner heat exchanger 2 through an open OC/EX, that is, entering the heat exchanger at the same pressure and temperature at the exit of the inner condenser. In this way, the inner heat exchanger 2 provides additional condensing surface and at the same time serves as a preheater (with door fully open, thereby allowing the preheated cabin air to enter the inner condenser). for the cabin air entering the inner condenser

The conditions tested and the relative capacity and effectiveness of the two systems operating in this manner are reported in the Tables 1 and 2 and illustrated for convenience as FIG. 3B, with the results from this Example 1 reported as EWG-HP and the results from Comparative Example 1 reported as WG-HP.

TABLE 1
Example operating conditions

| | Outdoor | | | | Water-Glycol | |
|---|---|---|---|---|---|---|
| | conditions | Indoor conditions | | | Condition | |
| | Ambient/ | Temp | Air | Target | Temp WG | |
| | Temp | Air | Flow | Temp at | In Tamb + | Flow |
| Test | Air In | In | Rate | Outlet | 5° C. | Rate |
| Name | [° C.] | [° C.] | [kg/min] | [° C.] | [° C.] | [L/min] |
| −30a | −30 | −30 | 4 | 50/Max | −25 | 8 |
| −20a | −20 | −20 | 6 | 50 | −15 | 8 |
| −20b | | 0 | 4 | | | |
| −10a | −10 | −10 | 6 | 50 | −5 | 8 |
| −10b | −10 | 5 | 4 | 50 | −5 | 8 |
| 0a | 0 | 0 | 6 | 50 | 5 | 8 |
| 0b | | 10 | 4 | | | |
| 5a | 5 | 5 | 4 | 50 | 10 | 8 |
| 15a | 15 | 15 | 4 | 40 | 20 | 8 |

TABLE 2
Temperature and pressure data

| | WG-HP | | | | | | | | EWG-HP | | | | | | | |
|---|---|---|---|---|---|---|---|---|---|---|---|---|---|---|---|---|
| | Condition | | | | | | | | | | | | | | | |
| | T4 | T5 | T6 | T7 | p1 | p2 | p3 | p4 | T4 | T5 | T6 | T7 | p1 | p2 | p3 | p4 |
| | Units | | | | | | | | | | | | | | | |
| | ° C. | ° C. | ° C. | ° C. | bar | bar | bar | bar | ° C. | ° C. | ° C. | ° C. | bar | bar | bar | bar |
| −30a | 27.52 | NA | −34.47 | 27.52 | 9.56 | NA | 0.81 | 9.56 | 18.00 | 5.34 | −35.89 | 18.00 | 5.34 | 18 | 5.34 | 5.34 |
| −20a | 36.2 | NA | −25.88 | 36.2 | 11.88 | NA | 1.18 | 11.88 | 23.49 | 6.54 | −27.82 | 23.49 | 6.54 | 23.49 | 6.54 | 6.54 |
| −20b | 60.59 | NA | −23.07 | 60.59 | 20.71 | NA | 1.33 | 20.71 | 48.35 | 12.52 | −24.87 | 48.35 | 12.52 | 48.35 | 12.52 | 12.52 |
| −10a | 55.27 | NA | −15.76 | 55.27 | 18.84 | NA | 1.78 | 18.84 | 44.99 | 11.53 | −18.22 | 44.99 | 11.53 | 44.99 | 11.53 | 11.53 |
| −10b | 58.94 | NA | −13.89 | 58.94 | 19.99 | NA | 1.92 | 19.99 | 50.44 | 13.16 | −15.30 | 50.44 | 13.16 | 50.44 | 13.16 | 13.16 |
| 0a | 60.37 | NA | −6.43 | 60.37 | 20.61 | NA | 2.52 | 20.61 | 51.42 | 13.47 | −8.29 | 51.42 | 13.47 | 51.42 | 13.47 | 13.47 |
| 0b | 57.33 | NA | −4.45 | 57.33 | 19.3 | NA | 2.71 | 19.3 | 50.73 | 13.25 | −5.32 | 50.73 | 13.25 | 50.73 | 13.25 | 13.25 |
| 5a | 58.95 | NA | −0.02 | 58.95 | 19.99 | NA | 3.15 | 19.99 | 50.64 | 13.22 | −1.04 | 50.64 | 13.22 | 50.64 | 13.22 | 13.22 |
| 15a | 42.57 | NA | 10.78 | 42.57 | 13.84 | NA | 4.48 | 13.84 | 40.57 | 10.33 | 10.49 | 40.57 | 10.33 | 40.57 | 10.33 | 10.33 |

In the table above, the temperature and pressure conditions correspond to those indicated in FIGS. 2A and 2B hereof, where applicable.

From the results reported above, it can be seen that the present thermal management system produces in this operating mode a COP on average 34.1% (22.3%-43.1%) higher than the prior heat pump systems and a heating capacity that is on average 7.0% (5.4%-9.2%) higher than the prior systems, for conditions −30a, −20a and −10a conditions.

### Comparative Example 2—Air Conditioning Mode

A prior heat pump provides air conditioning to an EV using the typical configuration illustrated in Comparative FIG. 2. In this configuration in an prior air conditioning cycle in which cabin air is to be cooled, the OHE 3 is the predominate source for condensing the refrigerant and the evaporator 3 cooling unit for cabin air.

Applicants have come to appreciate that while heat pump systems need an evaporative heat (energy) source, EVs also have cooling needs that represent waste heat for the evaporative source (highly efficient) and that an improved system to take advantage of these features is possible. In particular, applicants have noted that there are two main areas that need cooling on all EVs:
1. The battery needs cooling during charging and may, at times, need cooling during discharging (vehicle operation). The battery may also need warming initially in very cold weather.
2. The vehicle drive motor(s)/inverter require cooling during vehicle operation. These devices also benefit in efficiency from warming in cold weather.
   Unfortunately for system of prior designs, the cooling needs and the ideal temperatures of the battery and motor/Inverter vary greatly depending on the vehicle ambient conditions, the driving conditions, stationary battery charging, how long the vehicle has been off before running or how long the vehicle has been driving. In some circumstances, one or both of these (battery or motor/inverter) may need cooling while the other does not or may need warming.

### Examples 2-19

Applicants have come to appreciate that it is possible to achieve the most efficient evaporative heat conditions for the heat pump by the present highly flexible system which is able to use the available heat while not compromising the other sources. The present system provides highly beneficial performance by unique combinations of components, including the possibility to use three evaporative heat source locations (chiller, Outside Heat Exchanger [OHE] or a Inner Heat Exchanger, while at the same time waste heat from the battery during charging and/or discharging can be used at the chiller or the OHE and ambient air can be used at the OHE or the Inner Heat Exchanger as the heat source. In addition, one or both of the above heat sources can be warming up while another is used as the evaporative heat source for the heat pump. In addition, an electrically operated Positive Temperature Coefficient (PTC) heater can also be used alone or in series with the evaporative heat sources at the chiller and/or the OHE. The available evaporative heat sources that the system design enables are listed below:
1. Air only (at the OHE)
2. Motor and inverter (at the OHE)
3. Motor and inverter (at the chiller)
4. Motor and Inverter and PTC (at the chiller)
5. Battery (at the chiller)
6. Battery and PTC (at the chiller)
7. Battery (at the OHE)
8. Motor, inverter and battery (at the chiller)
9. Motor, inverter, battery and PTC (at the chiller)
10. Motor, inverter, battery (at the OHE)
11. PTC (at the chiller)
12. PTC (at the OHE)
13. Motor, Inverter and PTC (at the OHE)
14. Motor, inverter, battery and PTC (at the OHE)
15. Battery and PTC (at the OHE)
16. Air only (at the chiller)
17. Battery, motor and inverter (at the chiller)
18. Dehumidification (at the evaporator)
   The applicable system operating modes for the evaporative heat sources and their use location are shown in the following Examples (with associated figures), with the relevant ambient temperatures (ambient) as well as the condition of the cabin being hot, cool, cold or acceptable to the passenger (OK). Furthermore, the condition of the battery, motor and inverter are specified as being hot, warm, cool or cold or acceptable (OK) are defined. The driving condition between start and comfort as well as the battery charge being active (Yes) or not active (No) are described. The applicable operating conditions for the different heat sources are indicated. In the Figures, thick lines in the vapor compression system indicate refrigerant flow at relatively high pressure (only line pressure drop from compressor discharge), dashed thick lines in the vapor compression system indicate refrigerant flow at a reduced pressure (after throttling in an expansion valve), and thin lines indicate refrigerant conduits (and corresponding units) that have been bypassed. Similarly, thick lines in the coolant section indicate active coolant flow and thin lines indicate coolant conduits that have been bypassed, while dashed thick lines indicate the coolant could optionally be flowing but is not for the results reported in the example.

### Example 2-Vehicle Heating Between 0 C and 15 C

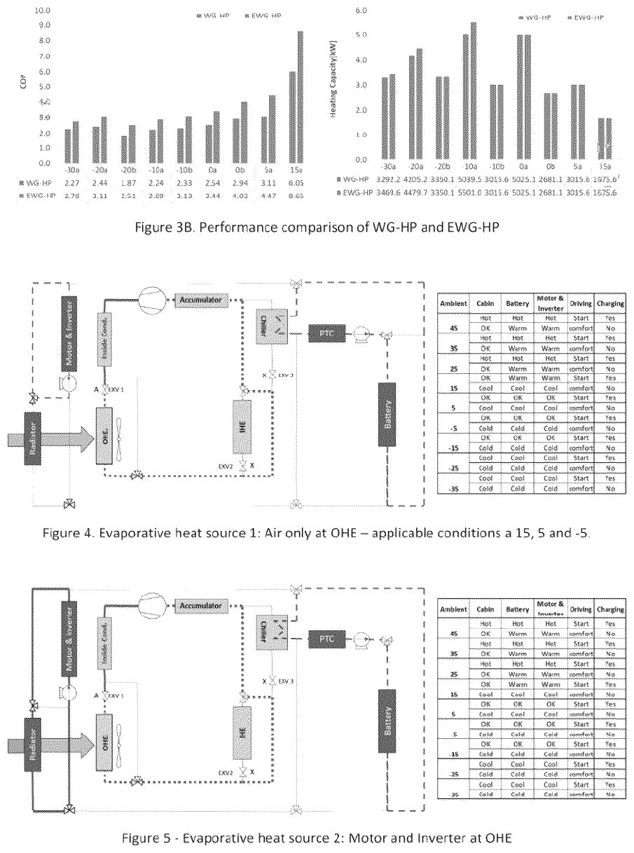

In this example, a system of the present invention is configured for operation to heat cabin air during periods of low ambient temperatures is illustrated in FIG. 4. The data obtained by operating the system of this example as indicated produces the results as reported in Table Example 2 below.

TABLE EXAMPLE 2
Temperature and pressure data

| Ambient | T4 | T5 | T6 | T7 | p1 | p2 | p3 | p4 |
|---|---|---|---|---|---|---|---|---|
| temperature | [C.] | [C.] | [C.] | [C.] | [bar] | [bar] | [bar] | [bar] |
| 15 C. | 10.6 | NA | 10.6 | 55.73 | 4.46 | NA | 4.46 | 18.64 |

This is an efficient mode for vehicle heating between 0 C and 15 C. It can and will likely be used in conjunction with self-heating of the battery and the motor and inverter either in series or parallel.

### Example 3—Vehicle Heating Between −10 C and 15 C

In this example, a system of the present invention is configured for operation to heat cabin air during periods of low ambient temperatures is illustrated in FIG. 5. The data obtained by operating the system of this example as indicated produces the results as reported in Table Example 3 below.

EXAMPLE 3 TABLE
Temperature and pressure data

| Ambient | T4 | T5 | T6 | T7 | p1 | p2 | p3 | p4 |
|---|---|---|---|---|---|---|---|---|
| temperature | [C.] | [C.] | [C.] | [C.] | [bar] | [bar] | [bar] | [bar] |
| 5 C. | 3.40 | NA | 3.40 | 58.95 | 2.20 | NA | 2.20 | 19.99 |

This is an efficient mode for vehicle heating between −10 C and 15 C after the motor and inverter are warmed up and need (or can tolerate) some cooling. It can and will likely be used in conjunction with self-heating of the battery or cooling of the battery at the chiller. This can also be used to de-ice the OHE.

### Example 4—Vehicle Heating Between −15 C and 15 C

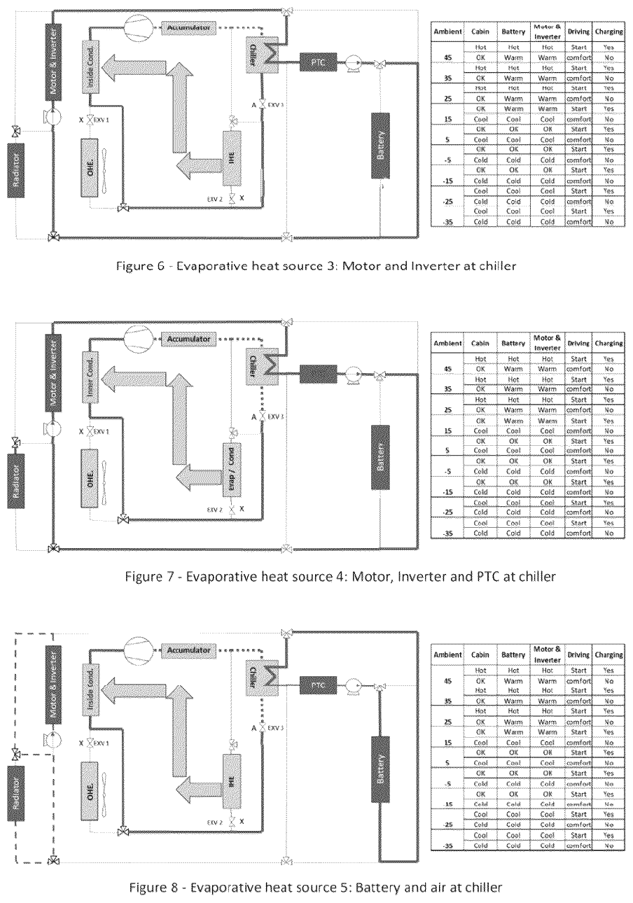

In this example, a system of the present invention is configured for operation to heat cabin air during periods of low ambient temperatures is illustrated in FIG. 6. The data obtained by operating the system of this example as indicated produces the results as reported in Table Example 4 below.

EXAMPLE 4 TABLE
Temperature and pressure data

| Ambient | T4 | T5 | T6 | T7 | p1 | p2 | p3 | p4 |
|---|---|---|---|---|---|---|---|---|
| temperature | [C.] | [C.] | [C.] | [C.] | [bar] | [bar] | [bar] | [bar] |
| −5 C. | 62.26 | NA | −13.05 | 62.26 | 21.45 | NA | 1.98 | 21.45 |

This is also an efficient mode for vehicle heating between −15 C and 15 C after the motor and inverter are warmed up and need or can tolerate some cooling. It can also be used to cool the motor and inverter in warm weather. It will likely be used when the battery is at an appropriate or acceptable temperature.

### Example 5—Motor and Inverter Temperature Control while Heating the EV

In this example, a system of the present invention is configured for operation to heat cabin air during periods of low ambient temperatures is illustrated in FIG. 7. The data obtained by operating the system of this example as indicated produces the results as reported in Table Example 5 below.

TABLE 5
Temperature and pressure data

| Ambient | T4 | T5 | T6 | T7 | p1 | p2 | p3 | p4 |
|---|---|---|---|---|---|---|---|---|
| temperature | [C.] | [C.] | [C.] | [C.] | [bar] | [bar] | [bar] | [bar] |
| −5 C. | 62.26 | NA | −13.05 | 62.26 | 21.45 | NA | 1.98 | 21.45 |

In this mode the motor and Inverter temperature can be maintained while heating the vehicle. In this case, the battery is assumed to be warming up while charging or at an appropriate temperature.

### Example 6—Vehicle Heating Between −25 C and 5 C with Battery Charging

In this example, a system of the present invention is configured for operation to heat cabin air during periods of low ambient temperatures is illustrated in FIG. 8. The data obtained by operating the system of this example as indicated produces the results as reported in Table Example 6 below.

EXAMPLE 6 TABLE
Temperature and pressure data

| Ambient | T4 | T5 | T6 | T7 | p1 | p2 | p3 | p4 |
|---|---|---|---|---|---|---|---|---|
| temperature | [C.] | [C.] | [C.] | [C.] | [bar] | [bar] | [bar] | [bar] |
| −15 C. | 60.59 | NA | −8.94 | 60.59 | 20.70 | NA | 2.30 | 20.70 |

This is an efficient mode for vehicle heating between −25 C and 5 C while the battery is charging. Excess heat from charging or from the charging source can be used to heat the vehicle.

### Example 7—Vehicle Heating with Ambient Between −35 C and 5 C with Battery Charging

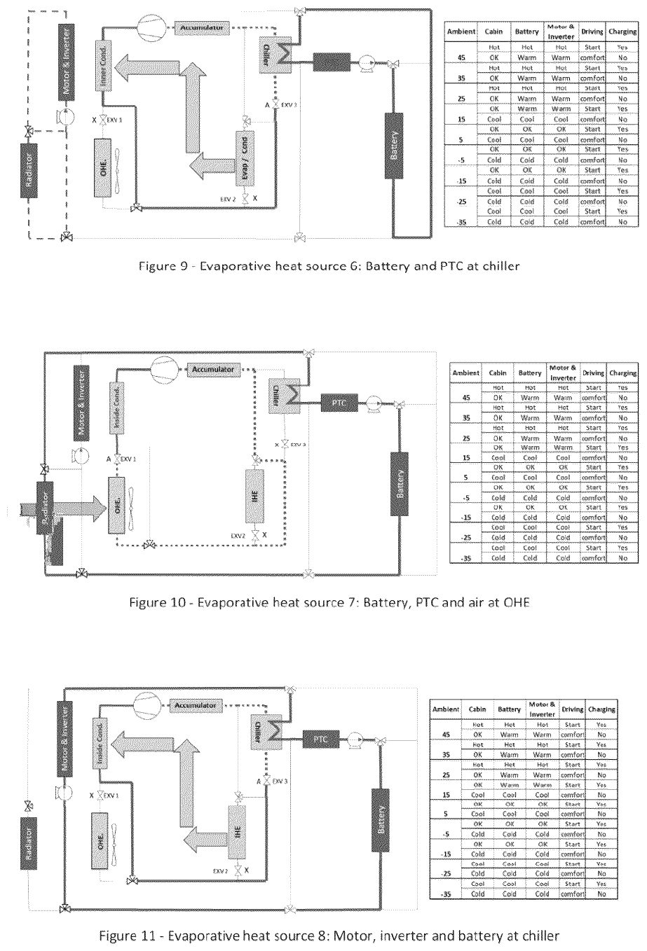

In this example, a system of the present invention is configured for operation to heat cabin air during periods of low ambient temperatures is illustrated in FIG. 9. The data obtained by operating the system of this example as indicated produces the results as reported in Table Example 7 below.

EXAMPLE 7 TABLE
Temperature and pressure data

| Ambient | T4 | T5 | T6 | T7 | p1 | p2 | p3 | p4 |
|---|---|---|---|---|---|---|---|---|
| temperature | [C.] | [C.] | [C.] | [C.] | [bar] | [bar] | [bar] | [bar] |
| −25° C. | 60.71 | NA | 5.60 | 60.71 | 20.76 | NA | 3.80 | 20.76 |

This is an efficient mode for vehicle heating while maintain the battery temperature between ambient conditions of −35 C and 5 C. This mode would likely be used at the start of a drive after charging.

### Example 8—Vehicle Heating with Ambient Between −15 C and 5 C with Battery Charging

In this example, a system of the present invention is configured for operation to heat cabin air during periods of low ambient temperatures is illustrated in FIG. 10. The data obtained by operating the system of this example as indicated produces the results as reported in Table Example 8 below.

EXAMPLE 8 TABLE
Temperature and pressure data

| Ambient | T4 | T5 | T6 | T7 | p1 | p2 | p3 | p4 |
|---|---|---|---|---|---|---|---|---|
| temperature | [C.] | [C.] | [C.] | [C.] | [bar] | [bar] | [bar] | [bar] |
| −5 C. | −6.69 | NA | −6.69 | 58.95 | 2.50 | NA | 2.50 | 19.99 |

This is an efficient mode for vehicle heating between −15 C and 5 C while the battery is charging. Excess heat from charging can be used to heat the vehicle at the OHE.

### Example 9—Vehicle Heating with Ambient Between −15 C and 15 C while Driving

In this example, a system of the present invention is configured for operation to heat cabin air during periods of low ambient temperatures is illustrated in FIG. 11. The data obtained by operating the system of this example as indicated produces the results as reported in Table Example 9 below.

EXAMPLE 9 TABLE
Temperature and pressure data

| Ambient | T4 | TS | T6 | T7 | p1 | p2 | p3 | p4 |
|---|---|---|---|---|---|---|---|---|
| temperature | [C.] | [C.] | [C.] | [C.] | [bar] | [bar] | [bar] | [bar] |
| −5 C. | 62.26 | NA | −13.27 | 62.26 | 21.45 | NA | 1.96 | 21.45 |

This is an efficient mode for vehicle heating between −15 C and 15 C while driving. Excess heat from the battery and motor and inverter can be used at the chiller. This can also be used with the enhanced heat pump configuration (dotted line).

### Example 10—Vehicle Heating with Ambient Between −25 C and 5 C while Driving

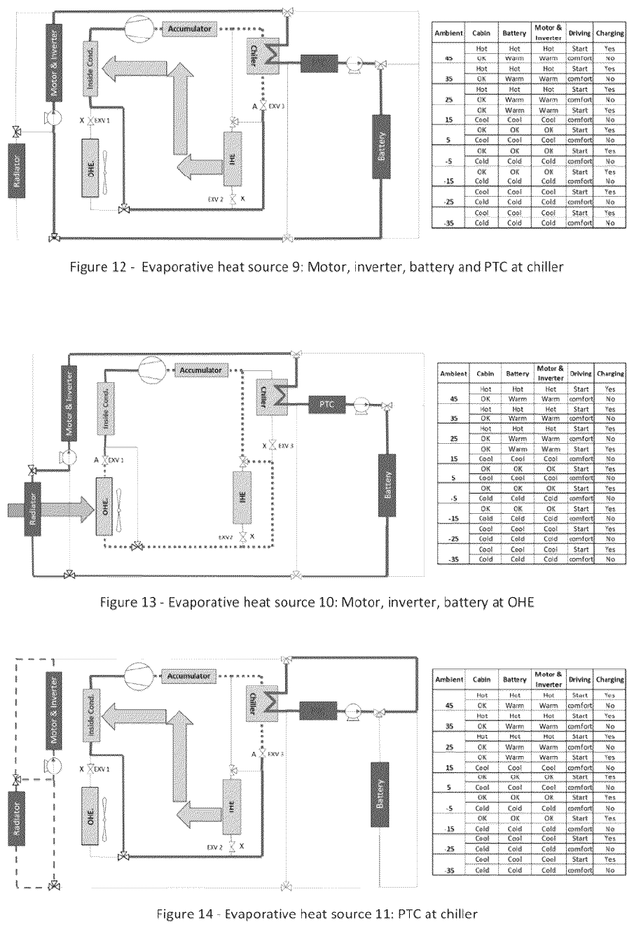

In this example, a system of the present invention is configured for operation to heat cabin air during periods of low ambient temperatures is illustrated in FIG. 12. The data obtained by operating the system of this example as indicated produces the results as reported in Table Example 10 below.

EXAMPLE 10 TABLE
Temperature and pressure data

| Ambient | T4 | T5 | T6 | T7 | p1 | p2 | p3 | p4 |
|---|---|---|---|---|---|---|---|---|
| temperature | [C.] | [C.] | [C.] | [C.} | [bar] | [bar] | [bar] | [bar] |
| −15 C. | 59.57 | NA | 22.77 | 59.57 | 20.58 | NA | 6.41 | 20.58 |

This is an efficient mode for vehicle heating between −25C and 5C while driving. PTC heat can be used to heat the vehicle while maintaining the battery and motor and inverter temperatures. This can also be used with the enhanced heat pump configuration (dotted line).

### Example 11—Vehicle Heating with Ambient Between −15 C and 15 C while Driving

In this example, a system of the present invention is configured for operation to heat cabin air during periods of low ambient temperatures is illustrated in FIG. 13. The data obtained by operating the system of this example as indicated produces the results as reported in Table Example 11 below.

TABLE EXAMPLE 11
Temperature and pressure data

| Ambient | T4 | T5 | T6 | T7 | p1 | p2 | p3 | p4 |
|---|---|---|---|---|---|---|---|---|
| temperature | [C.] | [C.] | [C.] | [C.] | [bar] | [bar] | [bar] | [bar] |
| 5 C. | 2.55 | NA | 2.55 | 58.95 | 3.44 | NA | 3.44 | 19.99 |

This is an efficient mode for vehicle heating between −15 C and 15 C while driving. Excess heat from the battery and motor and inverter can be used at the OHE. This can also be used to defrost the OHE in the event of freezing.

### Example 12—Vehicle Heating with Ambient Between −35 C and 5 C with Battery Charging

In this example, a system of the present invention is configured for operation to heat cabin air during periods of low ambient temperatures is illustrated in FIG. 14. The data obtained by operating the system of this example as indicated produces the results as reported in Table Example 12 below.

TABLE 12
Temperature and pressure data

| Ambient | T4 | T5 | T6 | T7 | p1 | p2 | p3 | p4 |
|---|---|---|---|---|---|---|---|---|
| temperature | [C.] | [C.] | [C.] | [C.] | [bar] | [bar] | [bar] | [bar] |
| −25° C. | 60.89 | NA | −7.04 | 60.89 | 20.84 | NA | 2.47 | 20.84 |

This is an efficient mode for vehicle heating between −35 C and −5 C after charging to prep the vehicle cabin before driving. Heat from the PTC is used by the heat pump to warm the cabin. This can also be used with the enhanced heat pump configuration (dotted line).

### Example 13—Vehicle Heating with Ambient Between −15 C and 5 C with Battery Charging or Driving

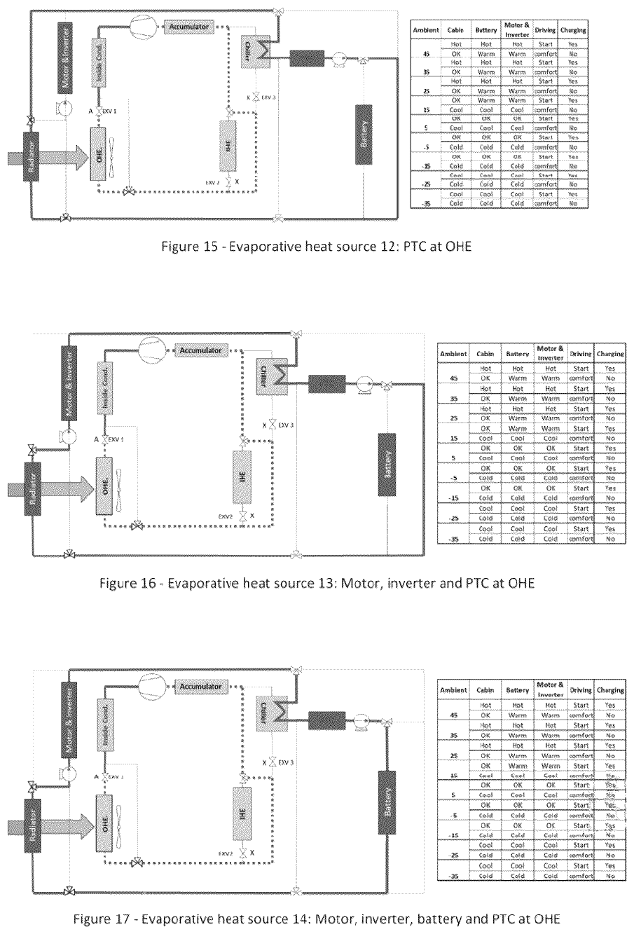

In this example, a system of the present invention is configured for operation to heat cabin air during periods of low ambient temperatures is illustrated in FIG. 15. The data obtained by operating the system of this example as indicated produces the results as reported in Table Example 13 below.

TABLE 13
Temperature and pressure data

| Ambient | T4 | T5 | T6 | T7 | p1 | p2 | p3 | p4 |
|---|---|---|---|---|---|---|---|---|
| temperature | [C.] | [C.] | [C.] | [C.] | [bar] | [bar] | [bar] | [bar] |
| −5 C. | −7.27 | NA | −7.27 | 62.27 | 2.45 | NA | 2.45 | 21.46 |

This is an efficient mode for vehicle heating between −15 C and 5 C while driving or charging when the battery and motor and inverter are at appropriate temperatures. Heat from the PTC can be used at the OHE.

### Example 14—Vehicle Heating with Ambient Between −15 C and 5 C

In this example, a system of the present invention is configured for operation to heat cabin air during periods of low ambient temperatures is illustrated in FIG. 16. This is a less efficient mode for vehicle heating between −15 C and 5 C while the motor and inverter are warming up (The PTC energy can be used). This can also be used to de-ice the OHE.

### Example 15—Vehicle Heating with Ambient Between −15 C and 5 C with Battery Charging

In this example, a system of the present invention is configured for operation to heat cabin air during periods of low ambient temperatures is illustrated in FIG. 17. This is a less efficient mode for vehicle heating between-15C and 15C while the motor and inverter and battery are warming up (the PTC energy can be used). This can also be used to de-ice the OHE.

### Example 16—Vehicle Heating with Ambient Between −15 C and 15 C with Component Warm Up

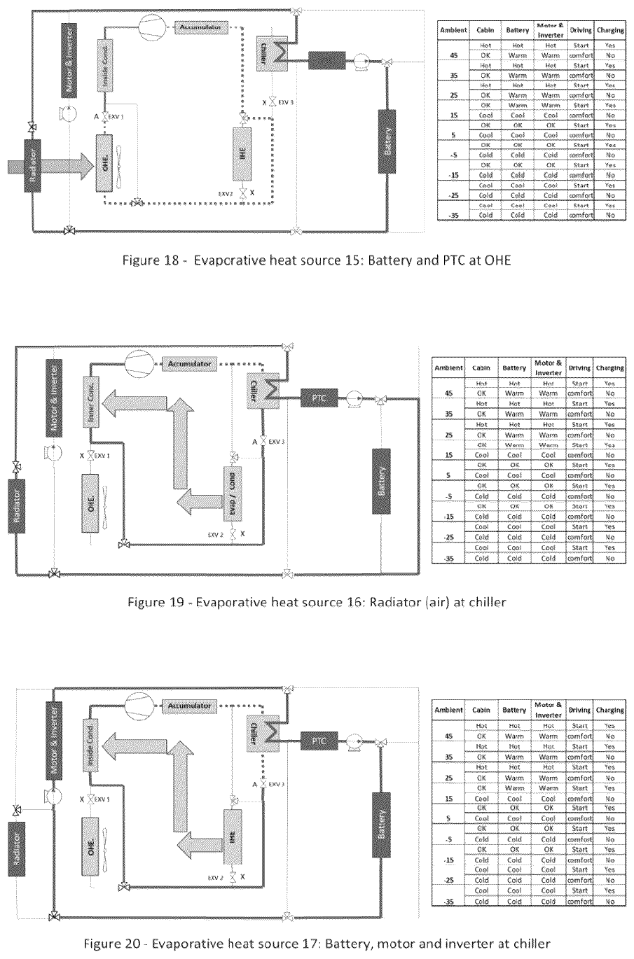

In this example, a system of the present invention is configured for operation to heat cabin air during periods of low ambient temperatures is illustrated in FIG. 18. This is a less efficient mode for vehicle heating between −15 C and 15 C while the motor and inverter and battery are warming up (the PTC energy can be used). This can also be used to de-ice the OHE.

### Example 17—Vehicle Heating with Ambient Between −15 C and 5 C

In this example, a system of the present invention is configured for operation to heat cabin air during periods of low ambient temperatures is illustrated in FIG. 19. This is also an efficient mode for vehicle heating between −5 C and 15 C. Energy from the air can be used at the chiller while not affecting the motor and Inverter or the battery.

### Example 18—Vehicle Heating with Ambient Between −15 C and 5 C after Component Warm-Up

In this example, a system of the present invention is configured for operation to heat cabin air during periods of low ambient temperatures is illustrated in FIG. 20. This is also an efficient mode for vehicle heating between-15C and 15C after the motor and inverter and battery are warmed up and need (or can tolerate) some cooling. It can also be used to cool the motor and inverter and battery in warm weather.

### Example 19A—De-Humidification

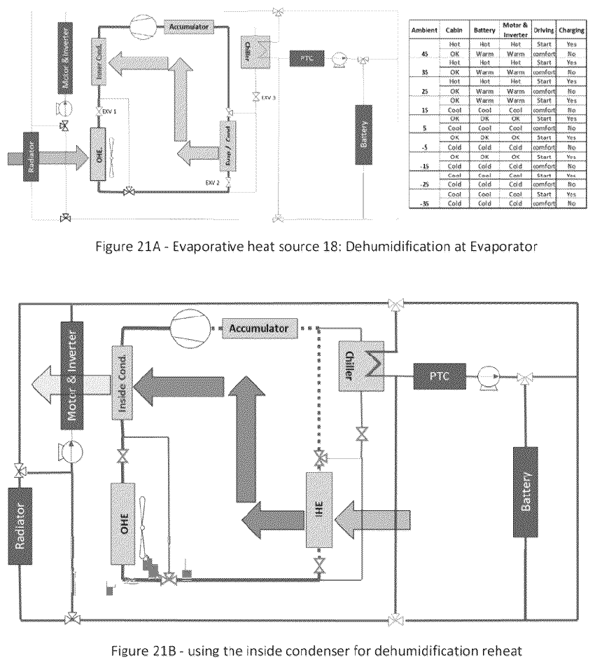

In this example, a system of the present invention is configured for operation to heat cabin air during periods of normal ambient temperatures is illustrated in FIG. 21A. The data obtained by operating the system of this example as indicated produces the results as reported in Table Example 19A below.

EXAMPLE 19A TABLE
Temperature and pressure data

| Ambient | T4 | T5 | T6 | T7 | p1 | p2 | p3 | p4 |
|---|---|---|---|---|---|---|---|---|
| temperature | [C.] | [C.] | [C.] | [C.] | [bar] | [bar] | [bar] | [bar] |
| 25 C. | 25.00 | 17.04 | NA | 35.00 | 8.95 | 5.42 | NA | 8.95 |

This is the normal mode for dehumidification where the air is cooled (below the dew point to remove moisture) and then reheated to achieve a more comfortable temperature for passengers. In very warm weather there would be less or no reheat but in milder conditions the dehumidification is necessary.

### Example 19B—De-Humidification

In this example, a system of the present invention is configured for operation to heat cabin air during periods of normal ambient temperatures is illustrated in FIG. 21B.

### Examples 20-27

In addition to the evaporative heat source flexibility provided by the present invention, several energy saving, warming and cooling configurations are advantageously provided.

The configurations shown on the following page show energy saving opportunities for many conditions.
Warming the battery with self-heating
Warming the battery with PTC heating
Warming the motor and inverter with self-heating
Warming the motor and inverter with PTC
Warming the battery, motor and inverter with self heating
Warming the battery, motor and inverter with PTC
Cooling the motor and inverter at the radiator
Cooling the motor and inverter @ the radiator (Battery @ chiller)
Cooling the battery at the radiator
Cooling the motor, inverter and battery at the radiator

### Example 20—Battery Warming

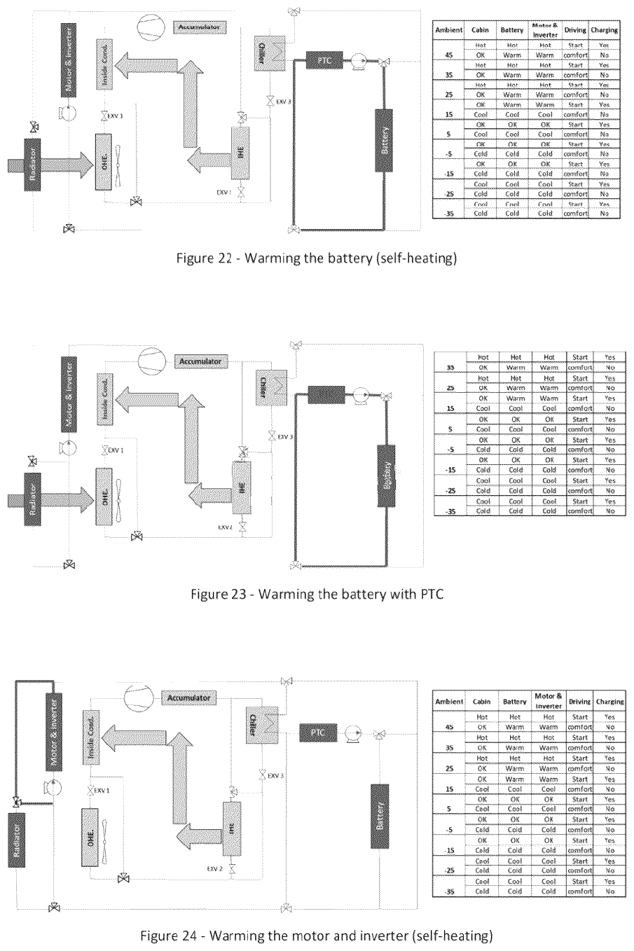

In this example, a system of the present invention is configured for operation to heat cabin air during periods of low ambient temperatures while also warming the battery is illustrated in FIG. 22. Circulating coolant to the battery helps the battery warm up more consistently either when charging or while driving.

### Example 21—Batter Heating—Very Cold Ambient

In this example, a system of the present invention is configured for operation to heat cabin air during periods of very low ambient temperatures is illustrated in FIG. 23. In cool to very cold weather the battery can be heated by circulating coolant heated by the PTC. This could be necessary before charging the battery in very cold weather. This could also improve charging time (decrease) in more mild but cool conditions. This could also be used to warm up the battery at the beginning of the drive cycle.

### Example 22—Motor and Inverter Self Heating

In this example, a system of the present invention is configured for operation to heat cabin air during periods of low ambient temperatures is illustrated in FIG. 24. Allowing the motor and Inverter in cold to cool weather to uniformly self-heat is important to achieve the best efficiency. Coolant can be circulated without removing heat.

### Example 23—Motor and Inverter Self Heating

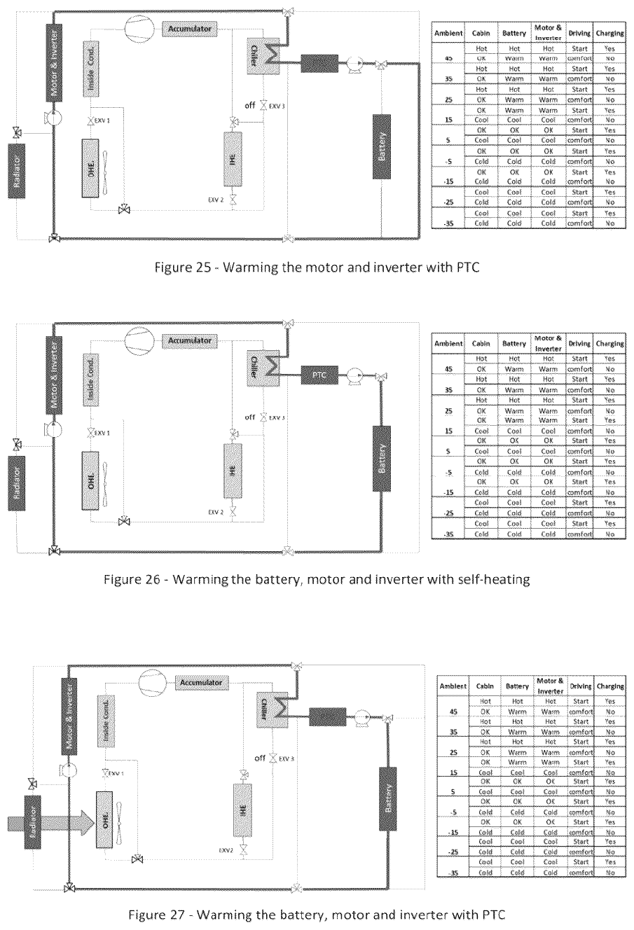

In this example, a system of the present invention is configured for operation to heat cabin air during periods of low ambient temperatures is illustrated in FIG. 25. Allowing the motor and Inverter in cold to cool weather to uniformly self-heat is important to achieve the best efficiency. PTC heat can be used to speed up the warm up. This may improve vehicle efficiency after charging and just prior to drive start.

### Example 24—Battery, Motor and Inverter Heating

In this example, a system of the present invention is configured for operation to heat cabin air during periods of low ambient temperatures is illustrated in FIG. 26. Circulating coolant through the motor/Inverter and battery would be an efficient way to warm both devices. This would likely be used during charging until cooling is necessary for the battery. It could also be used during driving to warm the battery until the desired temperature is reached when the battery would be removed from the loop.

### Example 25—Battery, Motor and Inverter Self Heating

In this example, a system of the present invention is configured for operation to heat cabin air during periods of low ambient temperatures is illustrated in FIG. 27. Circulating coolant through the motor/Inverter and battery would be an efficient way to warm both devices. PTC heat could also be used augment the warming. This would be appropriate while or prior to charging.

### Example 26—Motor and Inverter Cooling

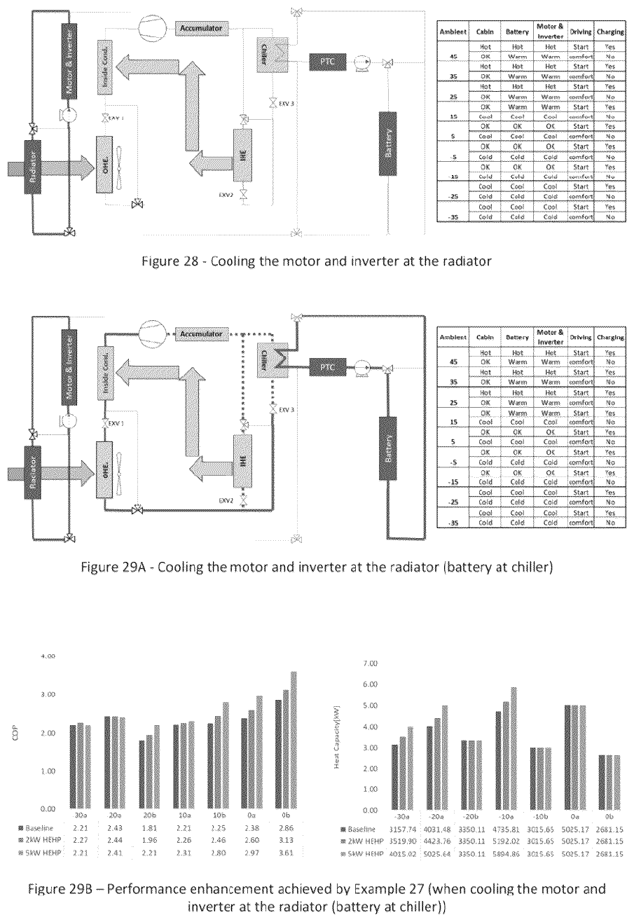

In this example, a system of the present invention is configured for operation to heat cabin air during periods of low ambient temperatures is illustrated in FIG. 28. In many ambient driving conditions it should be very efficient to cool the motor and inverter at the radiator as necessary without increasing the load on the AC system (at the chiller) which takes additional energy that is likely being used to keep the vehicle cool.

### Example 27—Motor and Inverter Self Heating

In this example, a system of the present invention is configured for operation to heat cabin air during periods of low ambient temperatures is illustrated in FIG. 29A. This mode (cooling the motor and inverter at the radiator) could also be used while cooling the battery at the Chiller. This would be the predominant component cooling mode in warm to hot weather. The Evaporator is used to cool the vehicle. In such a mode where the OHE is used, enhanced performance can be expected for such systems, as reported/illustrated in FIG. 29B in this and/or similar configurations in which the OHE is used.

### Example 28—Battery Cooling

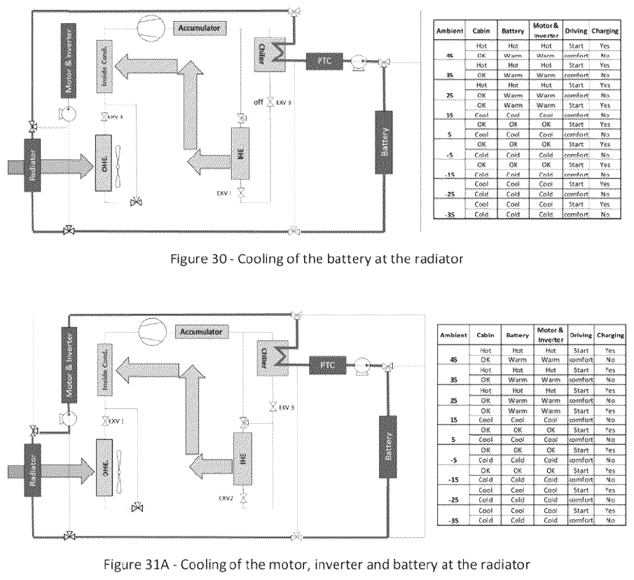

In this example, a system of the present invention is configured for operation to heat cabin air during periods of low ambient temperatures as is illustrated in FIG. 30. In many ambient cases the battery could also be cooled at the radiator to reduce energy usage (over the chiller). In warm to mild conditions this will be used during charging to remove heat from the battery.

### Example 29—Battery, Motor and Inverter Self Heating

In this example, a system of the present invention is configured for operation to heat cabin air during periods of low ambient temperatures is illustrated in FIG. 31. In many conditions, the motor, inverter and battery can be cooled at the radiator reducing energy consumption at the chiller. In cool to warm conditions this might be the predominant method of cooling the components.

### Example 30—Embodiments—Enhanced Efficiency without Compressor

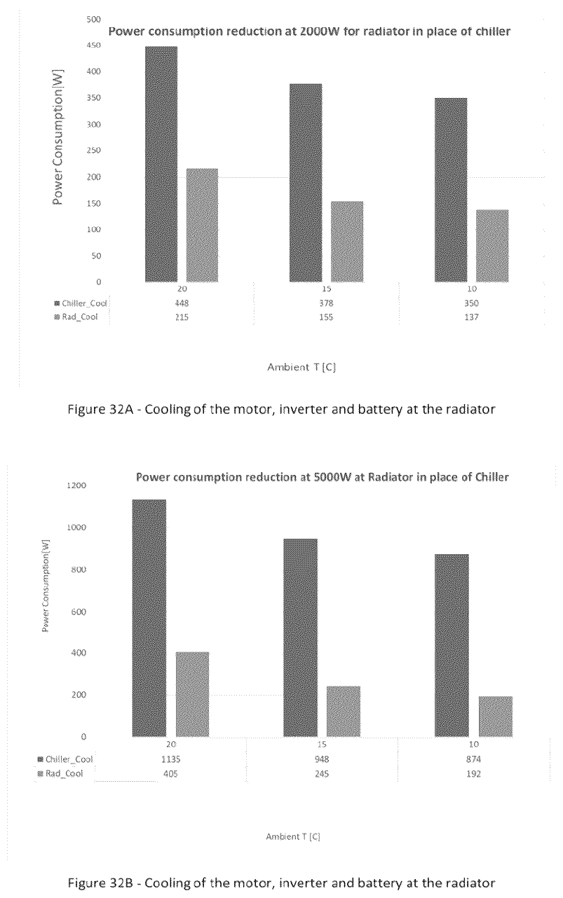

In this example, a system of the present invention is configured for operation to heat cabin air during periods of low ambient temperatures as illustrated in FIG. 31A. However, in this example, the present system provides operation as a heat pump in an EV to achieve efficiency improvement by rejecting heat without running the compressor and using radiator heat dissipation as opposed to using the chiller, as illustrated by the performance data for this Example 30 as shown in FIGS. 32A and 32B.

What is claimed is:

1. A heat transfer system to alternatively and/or simultaneously provide heating and cooling in a mobile vehicle that includes an electrical power source requiring heating and/or cooling during charging and/or operation and that includes a cabin that requires heat input during low temperature ambient conditions, said system comprising:
a) a vapor compression refrigeration circuit located in said mobile vehicle comprising:
(i) a first refrigerant,
(ii) a compressor for compressing said first refrigerant in the vapor state from a first pressure to a higher second pressure, said compressor being connected upstream to a refrigerant accumulator,
(iii) an inner condenser for selectively condensing during low temperature ambient conditions at least a portion of said first refrigerant vapor from said compressor by rejecting heat to said cabin,
(iv) an outside heat exchanger located downstream of said inner condenser to selectively either (1) condense during low temperature ambient conditions at least a portion of said higher pressure refrigerant vapor not condensed in said inner condenser by rejecting heat, directly or indirectly, to ambient air and/or to a circulating coolant or (2) evaporate during high temperature ambient conditions low pressure refrigerant liquid from said inner condenser vapor;
(v) a first open/closed/expansion device connected between said inner condenser and said outside heat exchanger for selectively (1) providing in an expansion mode a flow of reduced pressure liquid refrigerant from said inner condenser to said outside heat exchanger; (2) allowing in an open mode said condensed high pressure refrigerant from said condenser to pass to said outside condenser without pressure drop to said outside heat exchanger; or (3) preventing in a closed mode the flow of refrigerant from said inner condenser to said outside heat exchanger;
(vi) a inside heat exchanger fluidly connectable to said refrigerant downstream of said inner condenser for selectively providing heating to a flow of cabin air;
(vii) a chiller fluidly connectable to said refrigerant downstream of said inner condenser for selectively heating a flow of liquid coolant;
(viii) a bypass channel system connected upstream of said first open/closed/expansion device and downstream of said outside heat exchanger for selectively routing said refrigerant from said inner condenser and/or from said outside heat exchanger (1) around said first expansion device and to either (A) a second open/closed/expansion device fluidly connected to said inside heat exchanger for selectively (a) providing in an expansion mode a flow of reduced pressure liquid refrigerant from said inner condenser to said inside heat exchanger; (b) allowing in an open mode said condensed high pressure refrigerant from said condenser or from said outside heat exchanger to pass without pressure reduction to said inside heat exchanger; or (c) preventing in a closed mode the flow of refrigerant to said inside heat exchanger; and/or (B) an expansion device fluidly connected to said chiller for selectively (a) providing in an expansion mode a flow of reduced pressure liquid refrigerant to said chiller; or (b) preventing in a closed mode the flow of refrigerant to said chiller; or (2) through said first open/closed/expansion device operating in the expansion mode through said outside heat exchanger to said accumulator; and
b) a heat exchange network interconnected with said vapor compression refrigeration circuit to selectively; (i) deliver, directly or indirectly, at said outside heat exchanger and/or at said chiller evaporative heat from one or more of ambient air and/or heat associated with the generation or use of electrical power within the vehicle and/or at said inside heat exchanger either directly or indirectly from (1) ambient air and/or (2) said electrical power source located in said vehicle.

2. The system of claim 1 wherein said refrigerant comprises 2,3,3,3-tetrafluoropropene (R-1234yf).

3. The system of claim 1 wherein said refrigerant consists essentially of 2,3,3,3-tetrafluoropropene (R-1234yf).

4. The system of claim 1 wherein said refrigerant consists of 2,3,3,3-tetrafluoropropene (R-1234yf).

5. The system of claim 1 wherein the heat exchange network comprises a coolant circuit that comprises a coolant that absorbs waste heat from an electrical power source located in said vehicle during low temperature ambient conditions and rejects heat to said refrigerant in said chiller.

6. A mobile vehicle having one or more electric traction motors and one or more batteries and/or capacitors providing electric current to said one or more traction motors comprising a heat transfer system carried by said mobile vehicle to alternatively and/or simultaneously provide heating and cooling in said mobile vehicle, wherein heating and/or cooling is provided to said one or more batteries and/or capacitors during charging and/or operation and that includes a cabin that requires heat input during low temperature ambient conditions, wherein said heat transfer system comprises:
a) a vapor compression refrigeration circuit located in said mobile vehicle comprising:
(i) a first refrigerant,
(ii) a compressor for compressing said first refrigerant in the vapor state from a first pressure to a higher second pressure, said compressor being connected upstream to a refrigerant accumulator,
(iii) an inner condenser for selectively condensing during low temperature ambient conditions at least a portion of said first refrigerant vapor from said compressor by rejecting heat to said cabin,
(iv) an outside heat exchanger located downstream of said inner condenser to selectively either (1) condense during low temperature ambient conditions at least a portion of said higher pressure refrigerant vapor not condensed in said inner condenser by rejecting heat, directly or indirectly, to ambient air and/or to a circulating coolant or (2) evaporate during high temperature ambient conditions low pressure refrigerant liquid from said inner condenser vapor;
(v) a first open/closed/expansion device connected between said inner condenser and said outside heat exchanger for selectively (1) providing in an expansion mode a flow of reduced pressure liquid refrigerant from said inner condenser to said outside heat exchanger; (2) allowing in an open mode said condensed high pressure refrigerant from said condenser to pass to said outside condenser without pressure drop to said outside heat exchanger; or (3) preventing in a closed mode the flow of refrigerant from said inner condenser to said outside heat exchanger;
(vi) a inside heat exchanger fluidly connectable to said refrigerant downstream of said inner condenser for selectively providing heating to a flow of cabin air;
(vii) a chiller fluidly connectable to said refrigerant downstream of said inner condenser for selectively heating a flow of liquid coolant;
(viii) a bypass channel system connected upstream of said first open/closed/expansion device and downstream of said outside heat exchanger for selectively routing said refrigerant from said inner condenser and/or from said outside heat exchanger (1) around said first expansion device and to either (A) a second open/closed/expansion device fluidly connected to said inside heat exchanger for selectively (a) providing in an expansion mode a flow of reduced pressure liquid refrigerant from said inner condenser to said inside heat exchanger; (b) allowing in an open mode said condensed high pressure refrigerant from said condenser or from said outside heat exchanger to pass without pressure reduction to said inside heat exchanger; or (c) preventing in a closed mode the flow of refrigerant to said inside heat exchanger; and/or (B) an expansion device fluidly connected to said chiller for selectively (a) providing in an expansion mode a flow of reduced pressure liquid refrigerant to said chiller; or (b) preventing in a closed mode the flow of refrigerant to said chiller; or (2) through said first open/closed/expansion device operating in the expansion mode through said outside heat exchanger to said accumulator; and
b) a heat exchange network interconnected with said vapor compression refrigeration circuit to selectively; (i) deliver, directly or indirectly, at said outside heat exchanger and/or at said chiller evaporative heat from one or more of ambient air and/or heat associated with the generation or use of electrical power within the vehicle and/or at said inside heat exchanger either directly or indirectly from (1) ambient air and/or (2) said electrical power source located in said vehicle.

7. The mobile vehicle of claim 6 wherein said refrigerant comprises 2,3,3,3-tetrafluoropropene (R-1234yf).

8. The mobile vehicle of claim 6 wherein said refrigerant consists essentially of 2,3,3,3-tetrafluoropropene (R-1234yf).

9. The mobile vehicle of claim 6 wherein said refrigerant consists of 2,3,3,3-tetrafluoropropene (R-1234yf).

10. The mobile vehicle of claim 6 wherein the heat exchange network comprises a coolant circuit that comprises a coolant that absorbs waste heat from an electrical power source located in said vehicle during low temperature ambient conditions and rejects heat to said refrigerant in said chiller.
